(19) United States
(12) Patent Application Publication
(10) Pub. No.: US 2026/0008945 A1
(43) Pub. Date: Jan. 8, 2026

(54) Conductive adhesive and Preparation Method therefor, Slurry and Preparation Method therefor, and Lithium-ion Battery

(71) Applicant: FULLYMAX BATTERY CO., LTD., Huizhou (CN)

(72) Inventors: Jianxiang DENG, Huizhou (CN); Changhao LIU, Huizhou (CN)

(73) Assignee: FULLYMAX BATTERY CO., LTD., Huizhou, GD (CN)

(21) Appl. No.: 19/325,463

(22) Filed: Sep. 10, 2025

Related U.S. Application Data
(63) Continuation-in-part of application No. 18/314,829, filed on May 10, 2023.
Application No. 18/314,829 is a continuation of application No. PCT/CN2021/109413, filed on Jul. 29, 2021.

(30) Foreign Application Priority Data
Jun. 29, 2021 (CN) 202110732371.9

(51) Int. Cl. C09J 9/02; C09J 5/06; C09J 11/04; C09J 101/28; C09J 109/06; C09J 127/16; C09J 133/02; H01M 4/04; H01M 4/587; H01M 10/0525

(52) U.S. Cl. CPC C09J 9/02; C09J 5/06; C09J 11/04; C09J 101/28; C09J 109/06; C09J 127/16; C09J 133/02; H01M 4/0445; H01M 4/587; H01M 10/0525

(57) ABSTRACT

A conductive adhesive and its preparation method, a slurry and its preparation method, a silicon-containing lithium-ion battery and a computer-readable storage medium are provided. The conductive adhesive is consisted of a conductive agent, a binder and a solvent. The conductive agent is consisted of conductive spherical node substance, conductive fiber transition substance and tubular conductive substance. The conductive spherical node substance is at least one of carbon back, furnace black, acetylene black and Ketjen black. The conductive fiber transition substance is carbon fiber. The tubular conductive substance is single-walled carbon nanotube and/or few-walled carbon nanotube. The conductive adhesive of the present application has good dispersibility and high electrical conductivity.

### TECHNICAL FIELD

The present invention relates to the field of battery technology, particularly to a conductive adhesive and its preparation method, a slurry and its preparation method, a silicon-containing lithium-ion battery and a computer-readable storage medium.

### DESCRIPTION OF THE RELATED ART

Conductive agent, as an important part of battery slurry, plays a role in assisting electronics to move between cathode and anode to achieve taking off or embedding of lithium ion. Conductive agent is critical to energy density, battery rate and cycling efficiency. Therefore, the key is to choose appropriate conductive agent to acquire high energy density, long cycle life and high battery rate for lithium batteries.

Currently, main issues found in the use of conductive agent in lithium-ion batteries are following: (1) conductive agent particles are small, they are usually dozens nanometer which leads to poor dispersion, complicated dispersion process. Usually, attentions shall be not only given to mechanical operations, but also to dispersion procedure, for example, the order issue of exclusive dispersion agent and conductive agent for each time for different quantity; (2) conductivity of conductive agent is not high enough. Currently, increasing conductivity is to add metal powder content in conductive agent. However, adding metal powder content will not only increase costs significantly, but also reduces the content of active substances, lowers the energy density of the battery, and after the conductivity rises to a certain extent, further increasing the content of the conductive agent will cause the conductivity to decline, resulting in insufficient conductivity.

### SUMMARY OF THE INVENTION

This invention purpose is to overcome shortages in current technologies and to provide one category of Conductive adhesive and its preparation method, slurry and lithium battery with better dispersity and high conductivity.

In one aspect, the present invention provides a conductive adhesive being consisted of binder, solvent and conductive agent. The conductive agent is consisted of conductive spherical node substance, conductive fiber transition substance and tubular conductive substance. The conductive spherical node substance is at least one of carbon back, furnace black, acetylene black and Ketjen black. The conductive fiber transition substance is carbon fiber. The tubular conductive substance is single-walled carbon nanotube and/or few-walled carbon nanotube.

In another aspect, the present invention provides a preparation method for making the above conductive adhesive. The preparation method comprises the following steps:
performing a first mixing operation on binder and solvent so as to obtain a gel-containing solvent;
adding the tubular conductive substance to the gel-containing solvent and perform a second mixing operation;
adding the conductive fiber transition substance to the gel-containing solvent which has been subjected to the second mixing operation and perform a third mixing operation; and
adding the conductive spherical node substance to the gel-containing solvent which has been subjected to the third mixing operation and perform a fourth mixing operation.

In another aspect, the present invention provides a slurry including an active substance, a slurry-forming binder, and a slurry-forming solvent and the conductive adhesive described above.

In another aspect, the present invention provides a preparation method for making the above-described slurry. The preparation method comprises the following steps: mixing the active substance, the slurry-forming binder, the slurry-forming solvent, and the conductive adhesive to obtain a mixed slurry; and performing a debubbling operation on the mixed slurry. The debubbling operation comprises: performing a first debubbling treatment on the mixed slurry under a vacuum degree of P1; and performing a second debubbling treatment on the mixed slurry under another vacuum degree of P2 after the first debubbling treatment; wherein P1<0, P2<0, and P1<P2.

In another aspect, the present invention provides a computer-readable storage medium storing a computer program or instructions which can be executed to perform a preparation method for making the above-described slurry.

In another aspect, the present invention provides a silicon-containing lithium-ion battery which comprises an electrolyte and a negative electrode sheet in contact with the electrolyte, wherein at least one side of the negative electrode sheet is coated with a negative electrode slurry which comprises a silicon-based material, graphite, and the slurry, wherein a mass ratio of the silicon-based material to the graphite is 100:(0˜534).

In another aspect, the present invention provides a formation method for making the silicon-containing lithium-ion battery described above. The formation method comprises the following steps:
obtaining a pre-formed silicon-containing lithium-ion battery;
performing a pressurized heating formation operation on the pre-formed silicon-containing lithium-ion battery, wherein the pressurized heating formation operation specifically comprises the following steps:
performing a pre-swelling standing treatment on the pre-formed silicon-containing lithium-ion battery under a pressure of F1;
performing a swelling-suppression charging treatment on the pre-formed silicon-containing lithium-ion battery under a pressure F2 after the pre-swelling standing treatment;
performing a liquid absorption and slow-swelling standing treatment on the pre-formed silicon-containing lithium-ion battery under a pressure of F3 after the swelling-suppression charging treatment;
wherein

$$F 1 = F 2 and F 3 < F 1 .$$

In further another aspect, the present invention provides a computer-readable storage medium storing a computer program or instructions for being executed to perform the formation method for making the silicon-containing lithium-ion battery described above.

The details of one or more implemented cases of this invention are put forward in following attached figures and descriptions. Other characteristics, purposes and advantages of this invention can be apparently observed from instructions, attached figures and right claims.

### BRIEF DESCRIPTION OF THE DRAWINGS

It is to clearly explain implemented cases of this invention or technical solutions in current technologies. A brief introduction to attached figures that are needed in implemented cases or technical description will be made as below. Apparently, attached figures are only parts of implemented cases. For ordinary technicians in the field, they can acquire attached figures for other implemented cases based on these figures without making creative efforts.

FIGS. 1(a)˜1(f) show the negative electrode slurry prepared by the method according to Embodiment 3 and using the electrode slurry in group b3 and the corresponding negative electrode sheet obtained after coating and drying, wherein FIG. 1(a) shows the negative electrode slurry after mixing, FIG. 1(b) shows the negative electrode slurry after vacuuming and removing bubbles, FIGS. 1(c)-1(d) show the negative electrode slurry being coated on foils, FIG. 1(e) show the negative electrode sheet after drying, and FIG. 1(f) show microscope image of the negative electrode sheet.

FIGS. 2(a)˜2(b) show the negative electrode slurry prepared by the method according to Comparative Example 1 and using the electrode slurry in group b3 and the corresponding negative electrode sheet obtained after coating and drying, wherein FIG. 2(a) show the negative electrode sheet after being dried, and FIG. 2(b) show microscope image of the negative electrode sheet.

FIGS. 3(a) to 21(b) show the silicon-containing lithium-ion batteries obtained after formation according to Embodiments 6 to 17 and Comparative Examples 2 to 8 respectively, wherein FIGS. (3˜21)(a) are photos of the fully charged cell and FIGS. (3˜21)(b) are photos of the negative electrode sheet after being discharged.

### DETAILED DESCRIPTION

In order to understand this invention easily, full description is made for this invention in accordance with related attached figures as references. The attached figure provides best implementation way of this invention. However, the invention can be achieved by many different forms, it's not limited to the implementation way described in this file. On the contrary, the purpose of providing these implementation ways is to promote deep and full understanding of public contents of the invention.

Unless there is another definition, all technologies and scientific terms used in this file have the same meanings as understanding meaning of technicians working in this field related to the invention. Terms used in this file of the instruction are only for purpose of describing concrete implementation, they are not for limiting the invention. Terminologies used in this file “and/or” include random and all combination of one or more related listed projects.

The present invention provides a conductive adhesive which is consisted of a conductive agent, a binder, and solvent. The conductive agent is consisted of conductive spherical node substance, conductive fiber transition substance and tubular conductive substance. The conductive spherical node substance is at least one of carbon black (SP), acetylene black (AC), furnace black (AB), and Ketjen black (KB). The conductive fiber transition substance is carbon fiber (VGCF). The tubular conductive substance is single-walled carbon nanotubes (SWCNT) and/or few-walled carbon nanotubes (FWCNT). It is understood that the conductive adhesive contains only the conductive agent, the binder, and the solvent and does not contain any other components; and the conductive agent consists of the conductive spherical node substance, conductive fiber transition substance and tubular conductive substance and does not contain any other components. The conductive spherical node substance is at least one of carbon black, furnace black, acetylene black, and Ketjen black; the conductive fiber transition substance is carbon fiber; and the tubular conductive substance is single-walled carbon nanotubes and/or few-walled carbon nanotubes.

To facilitate an understanding of the conductive adhesive in the present application, a detailed description and explanation is provided as the following:

One conductive adhesive according to an embodiment of the present invention is consisted of a conductive agent, a binder, and solvent. The conductive agent is consisted of conductive spherical node substance, conductive fiber transition substance and tubular conductive substance. The conductive spherical node substance is at least one of carbon black, acetylene black, furnace black, and Ketjen black. The conductive fiber transition substance is carbon fiber. The tubular conductive substance is single-walled carbon nanotubes and/or few-walled carbon nanotubes.

The aforementioned conductive adhesive enables the combined use of conductive spherical node substance, conductive fiber transitional substance, and tubular conductive substances. The conductive substance with tubular structure exhibits excellent electron conduction capability, and can accelerate the conduction rate of electrons. The conductive spherical node substance increases the distribution density of conductive substance, providing more electron conduction contact points for lithium ions embedded in the slurry containing the conductive adhesive. The conductive fiber transitional substance, being relatively hard, effectively serves as a framework connecting the conductive tubular conductive substances and the conductive spherical node substance, forming a three-dimensional network structure, which not only facilitates rapid electron conduction within the slurry containing the conductive adhesive but also enhances the deintercalation capability of lithium ions embedded in the slurry, thereby significantly improving the overall conductivity of the conductive adhesive. Furthermore, the conductive agent is dispersed by using the binder and the solvent. The solvent provides sufficient space for the dispersion of the conductive agent, while the binder increases the viscosity of the solvent, preventing sedimentation of the conductive agent after dispersion to reduce the dispersibility of the conductive agent. This effectively enhances the dispersion stability of the conductive agent.

Furthermore, the conductive tubular conductive material, conductive fibrous transitional material, and conductive spherical node substance are mixed to form a point-line-plane three-dimensional network structure. This point-line-plane three-dimensional network structure is characterized by the conductive tubular conductive materials intersecting and distributed as planes, while the conductive fibrous transitional material enters into gaps formed between the conductive tubular conductive materials, enhancing the rigidity of the framework of the three-dimensional network structure and forming a porous structure. The conductive spherical node substance fills the framework of the three-dimensional network structure, increasing the distribution density of the conductive agent, thereby achieving the conductive adhesive with excellent stability and superior conductivity.

In an optional embodiment, the binder is a positive electrode binder or a negative electrode binder. Furthermore, the binder is at least one of polyvinylidene fluoride (PVDF), polytetrafluoroethylene (PTFE), polyacrylic acid (PAA), carboxymethyl cellulose (CMC), and styrene-butadiene rubber (SBR). Furthermore, the solvent is N-methyl-2-pyrrolidone (NMP) or water. Moreover, in the conductive adhesive used for the positive electrode slurry, the binder is PVDF and the solvent is NMP. In the conductive adhesive used for the negative electrode slurry, the binder is CMC and the solvent is water.

In an optional embodiment, the mass ratio of the binder, solvent, conductive spherical node substance, conductive fibrous transitional material, and conductive tubular conductive material is (0.5-2.0):(80-150):(0.5˜4):(0.1˜2):(0.02˜1). Furthermore, the mass ratio of the conductive spherical node substance, conductive fibrous transitional material, and conductive tubular conductive material is (0.5˜4):(0.1˜2):(0.02˜1). Moreover, when used in the positive electrode slurry, the mass ratio of the conductive spherical node substance, conductive fibrous transitional material, and conductive tubular conductive material is 1.5:0.5:0.1. When used in the negative electrode slurry, the mass ratio of the conductive spherical node substance, conductive fibrous transitional material, and conductive tubular conductive material is 1.5:0.5:0.05.

The present invention further provides a preparation method for making the above-mentioned conductive adhesives. The preparation method comprises the following steps:
performing a first mixing operation on binder and solvent so as to obtain a gel-containing solvent;
adding the tubular conductive substance to the gel-containing solvent and perform a second mixing operation;
adding the conductive fiber transition substance to the gel-containing solvent which has been subjected to the second mixing operation and perform a third mixing operation; and
adding the conductive spherical node substance to the gel-containing solvent which has been subjected to the third mixing operation and perform a fourth mixing operation.

Specifically, the method for preparing the conductive adhesive in one embodiment comprises the following steps:
S110, performing a first mixing operation on binder and solvent so as to obtain a gel-containing solvent. It is understandable that the binder and the solvent are mixed at the first step, which reduces the dispersion difficulty of the binder and improves its dispersion uniformity, while also lowers the dispersion intensity during the conductive agent dispersion process, thereby reducing the production cost of the conductive adhesive.
S130, adding the tubular conductive substance to the gel-containing solvent and perform a second mixing operation. It is understandable that the conductive tubular conductive material is first added to the gel-containing solvent for dispersion to preliminarily form a three-dimensional network structure. This reduces molecular interference and ensures the uniform dispersion of the conductive tubular conductive material in the gel-containing solvent.
S150, adding the conductive fiber transition substance to the gel-containing solvent which has been subjected to the second mixing operation and perform a third mixing operation. The conductive fiber transition substance is added to the gel-containing solvent with conductive tubular conductive material, which reduces molecular interference. Moreover, the conductive fiber transition substance can penetrate into the three-dimensional network structure formed by the conductive tubular conductive material, further refining the network structure. This enhances the rigidity of the framework of the three-dimensional network structure, resulting in a porous structure.
S170, adding the conductive spherical node substance to the gel-containing solvent which has been subjected to the third mixing operation and perform a fourth mixing operation. The conductive spherical node substance is added to the gel-containing solvent already containing the conductive tubular conductive material and the conductive fiber transition substance, which reduces intermolecular interference and facilitates the filling of the conductive spherical node substance into the refined three-dimensional network structure. This effectively increases the distribution density of the conductive adhesive, thereby significantly enhancing the electrical conductivity of the conductive adhesive.

In the aforementioned preparation method for the conductive adhesive, the binder and the solvent are mixed firstly, which reduces the dispersion difficulty of the binder and improves the dispersion uniformity of the binder. Subsequently, the conductive tubular conductive material is added to and dispersed in the gel-containing solvent to form an initial three-dimensional network structure. Next, the conductive fiber transition substance is added to the gel-containing solvent containing the conductive tubular material to further refine the three-dimensional network structure. This effectively enhances the connection rigidity of the skeleton of the three-dimensional network structure and forms a porous architecture. Finally, the conductive spherical node substance is added to the gel-containing solvent containing both the conductive tubular and fibrous materials, which facilitates the conductive spherical node substance filling into the refined three-dimensional network structure. This effectively increases the distribution density of the conductive adhesive, thereby significantly enhancing the electrical conductivity of the conductive adhesive.

It is understood that the above preparation method efficiently achieves the formation of the three-dimensional network structure of the conductive adhesive. The above preparation method is not the only way to form such a structure. The above method described in this application can make a conductive adhesive with a three-dimensional network structure more efficiently and with greater consistency.

In one embodiment, the first mixing operation is performed on the binder and solvent at a stirring speed of 800 r/min to 1500 r/min for 150 to 200 minutes. Furthermore, the second mixing operation is carried out at a stirring speed of 1800 r/min to 3500 r/min for 50 to 80 minutes. Subsequently, the third mixing operation is carried out at a stirring speed of 1500 r/min to 2500 r/min for 20 to 40 minutes. The fourth mixing operation is performed at a stirring speed of 1800 r/min to 3500 r/min for 100 to 150 minutes.

The present application further provides a slurry. The slurry comprises an active substance, a slurry-forming binder, and a slurry-forming solvent and the conductive adhesive described above. The conductive adhesive is consisted of a conductive agent, a binder, and solvent. The conductive agent is consisted of conductive spherical node substance, conductive fiber transition substance and tubular conductive substance. The conductive spherical node substance is at least one of carbon black, acetylene black, furnace black, and Ketjen black. The conductive fiber transition substance is carbon fiber. The tubular conductive substance is single-walled carbon nanotubes and/or few-walled carbon nanotubes.

The aforementioned slurry contains the conductive adhesive, effectively accelerating the conduction of electrons within the slurry and improving the deintercalation capability of the lithium ions embedded in the slurry.

In some embodiments, the slurry is consisted of an active substance, a slurry-forming binder, and a slurry-forming solvent and the conductive adhesive described above. Furthermore, the conductive adhesive is consisted of a conductive agent, a binder, and solvent. The conductive agent is consisted of conductive spherical node substance, conductive fiber transition substance and tubular conductive substance. The conductive spherical node substance is at least one of carbon black, acetylene black, furnace black, and Ketjen black. The conductive fiber transition substance is carbon fiber. The tubular conductive substance is single-walled carbon nanotubes and/or few-walled carbon nanotubes.

In one embodiment, the active substance is a positive electrode active material or a negative electrode active material. The slurry-forming binder is at least one of PVDF, PTFE, CMC, SBR, and PAA. The slurry-forming solvent is water or NMP. Furthermore, at least onekind of slurry-forming binder in the slurry is the same as the binder in the conductive adhesive. Furthermore, the slurry-forming solvent in the slurry is the same as the solvent in the conductive adhesive. Furthermore, when used for the positive electrode slurry, the mass ratio of the components in the slurry is: SP:VGCF:SWCNT:PVDF:NMP=96.4%:1.5%: 0.5%:0.1%:1.5%:(35%˜50%). Furthermore, when used for the negative electrode slurry, the mass ratio of the components in the slurry is: SP:VGCF:SWCNT:CMC:SBR:H₂O=94.95%:1.5%:0.5%:0.05%:1.5%:1.5%:(110%˜130%). Furthermore, when used for the anode slurry, the mass ratio of the components in the slurry is: SP:VGCF:SWCNT:CMC:PAA:H2O=95.45%:1.5%:0.5%:0.05%:0.5%:2.0%:(110%-130%).

It is understood that the combined use of the conductive spherical node substance, conductive fiber transition substance, and conductive tubular conductive material in the conductive adhesive forms a three-dimensional network structure, i.e., creating numerous open pores and interconnected channels. While this effectively enhances the rapid electron conduction and lithium-ion deintercalation capability of the conductive adhesive, it also results in an increased specific surface area of the conductive adhesive. The addition of such a high-surface-area conductive adhesive to the positive electrode or negative electrode slurry—particularly when SWCNT is used as the conductive tubular material—leads to a more significant increase in the specific surface area, accompanied by stronger surface activity. Moreover, since most components in the positive electrode or negative electrode slurry are nanoscale, a large number of micro-bubbles (i.e., bubbles with diameters less than 100 μm) are generated during the slurry preparation process. The micro-bubbles are difficult to remove. These residual bubbles can rupture during the electrode drying process, forming pits or even pinholes in the electrode, significantly affecting the battery's electrochemical performance.

Therefore, to ensure the electrochemical performance of the battery, the present application also provides a slurry preparation method for producing the slurry described in any of the above embodiments. The slurry preparation method comprises the following steps:

Mixing the active material, slurry-forming binder, slurry solvent, and conductive adhesive to obtain a mixed slurry; Performing a debubbling operation on the mixed slurry. Specifically, the debubbling operation comprises performing a first debubbling treatment on the mixed slurry under a vacuum degree of P1; performing a second debubbling treatment on the mixed slurry after the first treatment under a vacuum degree of P2; wherein P1<0, P2<0, and P1<P2.

To better understand the preparation method of the slurry in the present application, the following provides detailed description.

A preparation method for the slurry according to an embodiment of the present application includes the following steps:
S210: Perform a mixing process on an active material, a slurry-forming binder, a slurry-forming solvent, and a conductive adhesive to obtain a mixed slurry. It is understood that the mixing process is a conventional operation for uniformly mixing positive or negative electrode slurries.
S230: Perform a debubbling operation on the mixed slurry. The specific operation for debubbling the mixed slurry is as follows:
Perform a first debubbling treatment on the mixed slurry under a vacuum degree of P1;
Perform a second debubbling treatment on the mixed slurry, which has been subjected to the first debubbling treatment, under a vacuum degree of P2;
Where, P1<0, P2<0, and P1<P2. It is understood that tiny bubbles are difficult to rupture or merge. Debubbling operation on the mixed slurry first under the vacuum degree of P1 and then switching to the vacuum degree of P2, that is, decreasing the value of the vacuum degree first and then increasing the value of the vacuum degree. Thus, the bubbles expand and then contract, which promotes bubbles merging, thereby achieving a gradual increase in bubble particle size. Subsequently, when the vacuum degree is beyond the rupture point of the changed bubbles, bubbles are broken and removed. Thus, effective bubble removal is achieved and bubble removal efficiency is improved.

The aforementioned slurry preparation method first performs full and uniform mixing of the mixed slurry through the mixing process. Then, perform debubbling treatment on the mixed slurry first under the vacuum degree of P1 and then switching to the vacuum degree of P2, the value of the vacuum degree first decreases and then increases, achieving an effect of bubble expansion and contraction. This promotes bubble merging, thereby achieving a gradual increase in bubble particle size, and subsequently enables bubble rupture and removal when the vacuum degree changes is beyond the rupture point of the altered bubbles. Thus, effective bubble removal is achieved and bubble removal efficiency is improved.

It is understood that bubble removal in positive or negative electrode slurries is often achieved by vacuumization. Generally, a vacuum degree with a smaller value yields better debubbling result. However, for tiny bubbles, simply using a very small vacuum degree value, while improving the debubbling effect to some extent, can easily reach an equilibrium state. Even with a smaller vacuum degree value, bubble removal effectiveness cannot be further improved, preventing further effective bubble removal and efficiency enhancement. Therefore, in the present invention, by making the vacuum degree first increase and then decrease, achieving the expansion-contraction effect on bubbles, bubble merging is promoted, leading to a stepwise change in bubble size. Subsequently, bubble rupture and removal occur when the vacuum degree breaks the rupture point of the altered bubbles, achieving further effective bubble removal and increased bubble removal efficiency.

In one embodiment, the transition between P1 and P2 is a gradient change. Further, changing the vacuum degree of a container in which the mixing slurry is contained, to the vacuum degree of P1 at a vacuum degree change rate of −1 kPa/s to −9 kPa/s, and perform the first debubbling treatment on the mixed slurry. Further, increasing the value of the vacuum degree of the container from P1 to P2 at a vacuum degree change rate of −1 kPa/s to −9 kPa/s, and perform the second debubbling treatment on the mixed slurry. It is understood that a gradient change between P1 and P2 means vacuuming the container gradiently to cause the vacuum degree of the container changing from the atmospheric pressure or the vacuum degree of the previous operation step to the vacuum degree of P1, and then introducing air gradiently into the container to make the value of the vacuum degree of the container increase from P1 to P2. That is, the value of the vacuum degree of the container, in which the mixing slurry is contained, increases gradually from P1 to P2 with a vacuum degree change rate of −1 kPa/s to −9 kPa/s, a breathing-like effect of gradual expansion and contraction is achieved, further promoting bubble merging and leading to stepwise changes in bubble size. Thus, effective bubble removal is achieved and bubble removal efficiency is improved.

In one embodiment, the debubbling operation on the mixed slurry is performed under stirring conditions. Further, the debubbling operation is performed at a stirring speed of 3 rpm to 10 rpm. Further, in one embodiment, the debubbling operation is performed at a temperature of 10° C. to 45° C., preferably, 20° C. to 35° C. Further, during the process of the debubbling operation on the mixed slurry, the change rate of the vacuum degree is −1 kPa/s to −9 kPa/s.

In one embodiment, P1 is in a range of −90 kPa to −110 kPa. Further, P2 is in a range of −40 kPa to −60 kPa. Further, the number of repetitions of the debubbling operation on the mixed slurry is ≥20. Further, the number of repetitions of the debubbling operation is 20 to 40 times.

The present application also provides a computer-readable storage medium configured for storing a computer program or instructions which, when executed by a computing device or a controller, cause the implementation of the slurry preparation method described in any of the preceding embodiments. Further, this storage medium is not limited to storing programs/instructions for slurry preparation methods containing conductive adhesive; it can also separately store computer programs or instructions for executing the following slurry preparation method: mixing an active material, a binder, a solvent, and a conductive agent to obtain a mixed slurry; performing a debubbling operation on the mixed slurry, specifically: performing a first debubbling treatment on the mixed slurry under the vacuum degree of P1; performing a second debubbling treatment on the mixed slurry under the vacuum degree of P2; where P1<0, P2<0, and P1<P2. Further, the slurry preparation method includes: mixing the active material, the slurry-forming binder, the slurry-forming solvent, and the conductive adhesive to obtain a mixed slurry; performing a debubbling operation on the mixed slurry, specifically: performing a first debubbling treatment under vacuum degree of P1; performing a second debubbling treatment under vacuum degree of P2; where P1<0, P2<0, and P1<P2.

The present invention further discloses a slurry preparation equipment used to prepare the slurry. Further, the equipment is used to execute the slurry preparation method of any of the preceding embodiments. Further, this equipment is not limited to preparing slurries containing conductive adhesive; it can also be used separately to execute the following slurry preparation method: mixing an active material, a binder, a solvent, and a conductive agent to obtain a mixed slurry; performing a debubbling operation on the mixed slurry, specifically: a first debubbling under the vacuum degree of P1; a second debubbling under the vacuum degree of P2; where P1<0, P2<0, P1<P2. Further, the method includes: mixing an active material, a slurry-forming binder, a slurry-forming solvent, and a conductive adhesive to obtain a mixed slurry; performing a debubbling operation on the mixed slurry, specifically: a first debubbling under the vacuum degree of P1; a second debubbling under the vacuum degree of P2; where P1<0, P2<0, P1<P2.

The present application further provides a silicon-containing lithium-ion battery which at least includes an electrolyte and a negative electrode sheet in contact with the electrolyte. At least one side of the negative electrode sheet is coated with a negative electrode slurry. The negative electrode slurry includes a silicon-based material, graphite, and the slurry from any of the preceding embodiments. The mass ratio of silicon-based material to graphite is 100:(0˜534). Further, in this embodiment, the slurry includes an active material, a slurry-forming binder, a slurry-forming solvent, and the conductive adhesive from any preceding embodiment. Further, in this embodiment, the conductive adhesive consists of a conductive agent, a binder, and a solvent. The conductive agent consists of conductive spherical node substances, conductive fiber transition substances, and conductive tubular conduction substances. The conductive spherical node substances are at least one of carbon black, furnace black, acetylene black, and Ketjen black; the conductive fiber transition substance is carbon fiber; the conductive tubular conduction substances are single-walled carbon nanotubes and/or few-walled carbon nanotubes. Further, the mass ratio of silicon-based material to graphite is 100:(1˜534). Further, the mass ratio of silicon-based material to graphite is 100:(100˜500).

In the aforementioned slurry, the conductive adhesive effectively improves the rapid conduction of electrons within the slurry and enhances the deintercalation ability of lithium ions intercalated in the slurry.

In one embodiment, the silicon-containing lithium-ion battery at least includes an electrolyte and a negative electrode sheet. The electrolyte contacts the negative electrode sheet. At least one side of the negative electrode sheet is coated with a negative electrode slurry. The negative electrode slurry includes a silicon-based material, graphite, and the slurry from any preceding embodiment. The mass ratio of silicon-based material to graphite is 100:(0˜534). Further, in this embodiment, the slurry consists of an active material, a slurry-forming binder, a slurry-forming solvent, and the conductive adhesive from any preceding embodiment. Further, in this embodiment, the conductive adhesive consists of a conductive agent, a binder, and a solvent. The conductive agent consists of conductive spherical node substance, conductive fiber transition substance, and conductive tubular conduction substance. The conductive spherical node substance is at least one of carbon black, furnace black, acetylene black, and Ketjen black; the conductive fiber transition substance is carbon fiber; the conductive tubular conduction substance is single-walled carbon nanotubes and/or few-walled carbon nanotubes.

It is understood that in silicon-containing lithium-ion batteries, the negative active material contains silicon-based material, which can expand in volume by up to 300% during lithiation. This makes electrode pulverization and cracking likely during formation. Furthermore, the conductive adhesive has a large specific surface area which provides more active sites during the formation of the silicon-containing lithium-ion battery. This promotes side reactions happened at the electrolyte-silicon interface, exacerbating gas generation and accumulation, enhancing local stress inhomogeneity, and easily aggravating pulverization and cracking during formation of the silicon-containing lithium-ion battery.

Therefore, in the present invention, in order to reduce pulverization and cracking of the silicon-containing lithium-ion battery, the battery is made using a specific formation method for silicon-containing lithium-ion batteries. The aforementioned formation method includes the following steps: obtain a pre-formed silicon-containing lithium-ion battery; perform a pressurized heating formation operation on the battery to be formed. The specific steps for the pressurized heating formation operation are as follows: perform a pre-swelling standing treatment on the pre-formed silicon-containing lithium-ion battery under pressure F1; perform a swelling-suppression charging treatment on the pre-formed silicon-containing lithium-ion battery under pressure F2; perform a liquid absorption slow-swelling standing treatment on the pre-formed silicon-containing lithium-ion battery under pressure F3; where

$$F 1 = F 2 , and F 3 < F 1 .$$

To better understand the formation method for the silicon-containing lithium-ion battery in this application, the following provides detailed description:

A formation method for silicon-containing lithium-ion batteries in one embodiment includes the following steps:
S310: Obtain a pre-formed silicon-containing lithium-ion battery. It is understood that the silicon-containing lithium-ion battery at least includes an electrolyte and a negative electrode sheet. The electrolyte contacts the negative electrode sheet and at least one side of the negative electrode sheet is coated with a negative electrode slurry. The electrolyte contacts the negative electrode sheet and works as an ion transport medium. At least one side of the negative electrode sheet is coated with a negative electrode slurry containing silicon-based material and graphite, and a mass ratio of silicon-based material to graphite is 100:(0˜534), which has a relatively high energy density. Further, the particle size D50 of the silicon-based material is ≤10 nm. Further, the silicon-based material is silicon-carbon negative material, silicon-oxygen negative material, nano-silicon negative material, or silicon alloy negative material. Further, the silicon content in the silicon-based material is 10% to 100%.
S330: Perform a pressurized heating formation operation on the pre-formed silicon-containing lithium-ion battery. The pressurized heating formation operation comprises the following steps:
Perform a pre-swelling standing treatment on the pre-formed silicon-containing lithium-ion battery under pressure F1;
Perform a swelling-suppression charging treatment on the pre-formed silicon-containing lithium-ion battery, which has been subjected to the pre-swelling standing treatment, under pressure F2;
Perform a liquid absorption slow-swelling standing treatment on the pre-formed silicon-containing lithium-ion battery, which has been subjected to the swelling-suppression charging treatment, under pressure F3;
where

$$F 1 = F 2 , and F 3 < F 1 .$$

It is understood that before pressurized charging, the pre-formed silicon-containing lithium-ion battery first undergoes pre-swelling standing treatment. That is, the silicon-containing lithium-ion battery is subjected to pressurized heating standing under pressure F1, allowing pressure to transfer uniformly to all parts of the layer structures formed by the silicon-containing negative electrode slurry on the negative electrode sheet. Thus, pressure across the negative electrode sheet is balanced, enabling uniform and sufficient air expulsion before the expansion of silicon due to lithium intercalation. This avoids the formation of a thick and unstable SEI film due to the repeated rupture and regeneration of the SEI film caused by the combined effect of gas accumulation and silicon expansion during lithium intercalation. A thick and unstable SEI film will aggravate the occurrence of side reactions and cause the problem of local stress accumulation in the layer structure formed by the silicon-containing negative electrode slurry on the negative electrode sheet. Before pressurized charging, the pre-formed silicon-containing lithium-ion battery first undergoes pre-swelling standing treatment, which improves local stress homogeneity and the stability of the SEI film. Since the layer structure formed from the negative electrode slurry is actually a silicon-containing composite material, applying a pressure of F1 under the condition of heating reduces the yield strength of the silicon within the layer structure formed from the negative electrode slurry compared to pure silicon, making the silicon within the layer structure formed from the negative electrode slurry more prone to slip deformation under the action of an external force. The balanced pressure transfers through the layer structure's skeleton/framework to the silicon, making local stresses at the silicon sites in the layer structure formed from the negative electrode slurry much higher than the macroscopic pressure value, causing pre-plastic deformation of the silicon in the layer structure formed from the negative electrode slurry, which pre-releases uniformly the expansion potential energy of the layer structure formed from the negative electrode slurry. Additionally, heating softens the binder in the layer structure formed from the negative electrode slurry, allowing it to more uniformly encapsulate silicon-carbon particles, enhancing the binder's restraint on the silicon-carbon particles, helping to alleviate subsequent volume expansion during lithiation. In addition, the enhanced fluidity of components in the structure formed from the negative electrode slurry, with the combined effect of pressure and static standing, promotes rearrangement of silicon, binder and other components in the silicon-containing negative electrode slurry, increasing the surface compaction density of the layer structure formed from the negative electrode slurry while retaining internal expansion allowance, creating buffer pores within the layer structure formed from the negative electrode slurry. Heating facilitates reducing electrolyte viscosity, promoting uniform and sufficient infiltration of the electrolyte throughout the layer structure formed from the negative electrode slurry.

Then, under the pressure of F2 (where F2=F1), charging operation is continued under constant pressure, maintaining balanced compression across the layer structure formed from the negative electrode slurry. This ensures balanced expansion stress during the process of charging, reducing local stress peaks in the layer structure formed from the negative electrode slurry. The pre-release of expansion energy, enhanced binder restraint on the silicon-carbon particles, formation of buffer pores, and uniform and sufficient infiltration of the electrolyte throughout the layer structure, cooperatively mitigates cracking and pulverization of the layer structure formed from the negative electrode slurry effectively.

Subsequently, under the pressure of F3 (where F3<F1), the liquid absorption slow-swelling standing treatment is performed. That is, the pressure is reduced and the standing is continued. At this time, the layer structure formed by the silicon-containing negative electrode slurry on the negative electrode sheet of the silicon-containing lithium-ion battery does not undergo lithium intercalation but continues to expand. The reduced pressure allows electrolyte to flow back towards the negative electrode sheet. It also allows release of expansion stress in the layer structure formed by the silicon-containing negative electrode slurry on the negative electrode sheet of the silicon-containing lithium-ion battery and reduces binder fatigue of the silicon-containing negative electrode slurry on the negative electrode sheet. In addition, heating facilitates alleviating local stress concentration, effectively reducing pulverization and cracking of the layer structure formed by the silicon-containing negative electrode slurry on the negative electrode sheet of the silicon-containing lithium-ion battery, and improving the density and uniformity of the SEI film.

The above-mentioned formation method for silicon-containing lithium-ion batteries enables the negative electrode sheet to come into contact with the electrolyte, which effectively ensures the effect of the electrolyte as an ion transport medium. Moreover, the silicon-containing negative electrode slurry has a high energy density. By performing pressurized heating formation operations on the batteries to be formed, it not only ensures the energy density of the silicon-containing lithium-ion batteries but also effectively reduces the pulverization and cracking of the layer structure formed by the silicon-containing negative electrode slurry on the negative electrode sheet. It also reduces the uneven distribution of the electrolyte caused by compression, improving the compactness and uniformity of the SEI film, and thereby significantly enhancing the electrochemical performance of the silicon-containing lithium-ion batteries.

It is understandable that if F2 is not equal to F1, and under the pressure of F2, the pre-swelling and static standing treatment of the pre-formed silicon-containing lithium-ion battery is subjected to anti-swelling charging treatment, that is, charging treatment is carried out immediately after the application of pressure of F2. At this time, the pressure equilibrium of each part of the layer structure formed by the negative electrode slurry is poor. The charging and lithium intercalation will cause uneven local expansion stress in the layer structure formed by the negative electrode slurry, which will instead aggravate the pulverization and cracking of the layer structure formed by the negative electrode slurry. Especially, if F2 is greater than F1 during the anti-swelling static treatment, the buffer voids in the layer structure formed by the negative electrode slurry during the pre-swelling static treatment will be destroyed, that is, the expansion margin of the layer structure formed by the negative electrode slurry will be consumed, affecting the buffering effect of the layer structure formed by the negative electrode material on the volume expansion during charging and lithium intercalation. If F2 is less than F1 during the anti-swelling static standing treatment, the layer structure formed by the negative electrode material will slightly rebound, resulting in a poor contact effect with the negative electrode sheet, causing uneven current distribution, and further causing uneven local expansion stress in the layer structure formed by the negative electrode slurry, which will instead aggravate the pulverization and cracking of the layer structure formed by the negative electrode slurry.

It is also understandable to first subject the silicon-containing lithium-ion battery to a pre-swelling and static standing treatment.

In one embodiment, the pre-formed silicon-containing lithium-ion battery is subjected to a pressurized heating formation operation under a temperature of 35° C. to 80° C. It can be understood that in the pre-swelling static standing treatment, the effective increase of the fluidity of the electrolyte and the binder is well ensured, and in combination with the pressure of F1, the plastic deformation is effectively achieved in advance in the layer structure formed by the negative electrode material; and in the swelling suppression charging treatment, the migration ability of lithium ions is effectively accelerated, thereby achieving the rapid formation of the SEI film; and in the liquid absorption slow swelling static standing treatment, the redistribution of lithium ions is effectively accelerated, and the local stress concentration is effectively alleviated.

In one embodiment, the swelling-suppression charging treatment is performed at a current of 0.01 C to 0.5 C, conducive to forming a dense SEI film.

In one of the embodiments, the pre-formed silicon-containing lithium-ion battery is subjected to a pre-swelling and static standing treatment at the pressure of F1, with a static standing time of 5 minutes to 3 hours. This ensures the release of the expansion potential energy of the layer structure formed by the negative electrode slurry, the enhancement of the binding force of the binder on the silicon-carbon particles in the layer structure formed by the negative electrode slurry, the formation of buffer voids in the layer structure formed by the negative electrode slurry, and the uniform and thorough infiltration of the electrolyte into all parts of the layer structure formed by the negative electrode slurry.

In one embodiment, the pre-formed silicon-containing lithium-ion battery is subjected to a swelling-suppression charging treatment under the pressure of F2 lasts for 0.5 h to 10 h, ensuring sufficient formation of a dense SEI film.

In one embodiment, the liquid absorption slow-swelling standing treatment under pressure F3 lasts for 5 min to 3 h, ensuring sufficient electrolyte backflow and effective alleviation of stress concentration and release of expansion stress.

In one embodiment, the pre-formed silicon-containing lithium-ion battery, which has been subjected to the swelling-suppression charging treatment, is subjected to a liquid absorption and slow swelling static standing treatment under the pressure of F3 for 5 minutes to 3 hours, which effectively realizes the full reflux of the electrolyte at the negative electrode plate and effectively ensures the relief of local stress concentration and the slow release of swelling stress.

In one embodiment, the pressurized heating formation operation is performed on the pre-formed silicon-containing lithium-ion battery at least twice. It can be understood that by performing the pressurized heating formation operation on the pre-formed silicon-containing lithium-ion battery at least twice, that is, performing pressurized static standing charging and depressurized static standing charging in a breathing-like manner, the silicon-containing lithium-ion battery forms a complete and dense SEI through the step of performing the pressurized heating formation operation on the pre-formed silicon-containing lithium-ion battery once, and the expansion change value of the layer structure formed by the silicon-containing negative electrode slurry on the negative electrode sheet of the silicon-containing lithium-ion battery is relatively large. In the present invention, by performing the pressurized heating formation operation on the pre-formed silicon-containing lithium-ion battery at least twice, the pre-formed silicon-containing lithium-ion battery forms a complete and dense SEI, and the expansion change value of the layer structure formed by the silicon-containing negative electrode slurry on the negative electrode sheet of the silicon-containing lithium-ion battery is relatively small, which is beneficial to reducing the pulverization and cracking of the layer structure formed by the silicon-containing negative electrode slurry on the negative electrode sheet of the silicon-containing lithium-ion battery. That is, by performing the pressurized heating formation operation on the pre-formed silicon-containing lithium-ion battery at least twice, the expansion change value is distributed, which is beneficial to distributing and reducing the expansion stress of the layer structure formed by the silicon-containing negative electrode slurry on the negative electrode sheet of the silicon-containing lithium-ion battery, and thus effectively reduces the pulverization and cracking of the layer structure formed by the silicon-containing negative electrode slurry on the negative electrode sheet of the silicon-containing lithium-ion battery.

In one embodiment, the number of repeated pressurized heating formation operations performed on the pre-formed silicon-containing lithium-ion battery is 2 to 7 times. Further, the number of repeated pressurized heating formation operations performed on the pre-formed silicon-containing lithium-ion battery is 4 times. It can be understood that too many repetitions will bring the following adverse effects: 1. It will aggravate the structural damage and fatigue failure of the silicon anode material. During the lithium deintercalation process, silicon undergoes a huge volume change, usually over 300%, and each pre-formation cycle, the silicon particles will experience one expansion and contraction. Multiple cycles of expansion and contraction mean that the silicon particles will be subjected to multiple intense mechanical stress cycles, which will significantly accelerate the pulverization and cracking of the silicon particles and cause the failure of contact between the silicon-based material and the conductive agent, binder, etc. 2. Mechanical fatigue of the current collector and electrode structure. The expansion stress of the silicon-based material not only acts on the active material itself but also is transmitted to the conductive agent, binder, current collector, and separator. Each expansion and contraction is a stress cycle. Multiple cycles will accelerate the fatigue of the current collector, increasing the risk of micro-cracks and fractures; the fatigue failure of the binder, increasing the risk of coating detachment, and the loosening and deterioration of the overall electrode structure. 3. Continuous destruction and reconstruction of the SEI film, consuming excessive lithium and electrolyte. At the same time, it will intensify the interface side reactions and gas generation. Multiple cycles mean repeated destruction and reconstruction of the SEI film. Each time the SEI film breaks and rebuilds, it requires the consumption of active lithium ions and electrolyte solvents/additives to generate new SEI components. The repeated destruction of the SEI film exposes the fresh silicon surface continuously, providing a continuous site for side reactions. Multiple cycles provide more time and conditions for these side reactions to occur, significantly increasing the gas generation, which may lead to shell deformation and affect subsequent processes and safety performance.

In one embodiment, the step of performing pressurized and heated charging formation operation on the pre-formed silicon-containing lithium-ion battery is repeated at least twice. In each step of performing pressurized and heated charging formation operation on the pre-formed silicon-containing lithium-ion battery, F1, F2 and F3 are independently selected, that is, in each repeated step of performing pressurized and heated charging formation operation on the pre-formed silicon-containing lithium-ion battery, F1 in any step can be the same as or different from F1 in the other repeated steps; similarly, F2 in any step can be the same as or different from F2 in the other repeated steps; and similarly, F3 in any step can be the same as or different from F3 in the other repeated steps.

In one embodiment, the step of performing pressurized and heated charging formation operation on the pre-formed silicon-containing lithium-ion battery is repeated at least twice. In each step of performing pressurized and heated charging formation operation on the pre-formed silicon-containing lithium-ion battery, the current and temperature are independently selected, that is, in each repeated step of performing pressurized and heated charging formation operation on the pre-formed silicon-containing lithium-ion battery, the temperature in any step can be the same as or different from the temperature in the other repeated steps; similarly, the current in any step can be the same as or different from the current in the other repeated steps.

In one embodiment, F1 and F2 are independently selected from 2 kgf/cm² to 10 kgf/cm². Further, F3 is selected from 0.5 kgf/cm² to 5 kgf/cm². Further, F1 and F2 are independently selected from 4 kgf/cm² to 10 kgf/cm². It can be understood that when F1 and F2 are independently selected from 2 kgf/cm² to 10 kgf/cm² and F3 is selected from 0.5 kgf/cm² to 5 kgf/cm², which ensure the reduction of powdering and cracking of the layer structure formed by the silicon-containing negative electrode slurry on the negative electrode sheet of the silicon-containing lithium-ion battery, and ensure the improvement of the density and uniformity of the SEI film.

In one of the embodiments, before the step of performing the pressurized heating formation operation on the pre-formed lithium-ion battery containing silicon and after the step of obtaining the pre-formed lithium-ion battery containing silicon, the formation method of the lithium-ion battery containing silicon further includes the following steps:
Performing a pre-pressurized heating formation operation for the pre-formed silicon-containing lithium-ion battery, specifically including the following steps:
Performing a pre-swelling and standing pre-treatment on the pre-formed silicon-containing lithium-ion battery under the pressure of F4;
Performing a swelling suppression and charging pre-treatment on the pre-formed silicon-containing lithium-ion battery after the pre-swelling and standing pre-treatment under the pressure of F5;
Performing a liquid absorption and slow swelling standing pre-treatment on the pre-formed silicon-containing lithium-ion battery after the swelling suppression and charging pre-treatment under the pressure of F6;

### Wherein

$$F 4 = F 5 , F 6 \leq F 4 , F 4 < F 1 .$$

It is understandable that when performing the pre-pressurization and heating formation operation on the pre-formed silicon-containing lithium-ion battery, the charging formation of the pre-formed silicon-containing lithium-ion battery is in the initial stage of expansion of the layer structure formed by the negative electrode slurry, and the expansion stress is relatively small. Therefore, the expansion stress of the layer structure formed by the negative electrode slurry can be resisted by a relatively small pressure of F4, and the migration of the electrolyte at the negative electrode sheet under the pressure of F4 is reduced, which is conducive to the initial and full formation of a relatively dense SEI film and reduces the occurrence of side reactions. The pre-pressurization and heating formation operation includes pre-expansion and static standing pretreatment, expansion suppression charging pretreatment, and liquid absorption and slow expansion static standing pretreatment, which have the same purpose and effect as the pressurization and heating formation operation including pre-expansion and static standing treatment, expansion suppression charging treatment, and liquid absorption and slow expansion static standing treatment. It effectively reduces the pulverization and cracking of the layer structure formed by the silicon-containing negative electrode slurry on the negative electrode sheet of the silicon-containing lithium-ion battery, and reduces the uneven distribution of the electrolyte caused by squeezing, thereby improving the density and uniformity of the SEI film and further improving the electrochemical performance of the silicon-containing lithium-ion battery.

In one embodiment, the pre-formed silicon-containing lithium-ion battery after the pre-expansion and static standing pretreatment is subjected to expansion suppression charging pretreatment under a current of 0.01 C to 0.5 C, which is conducive to the formation of a dense SEI film.

In one embodiment, the pre-formed silicon-containing lithium-ion battery after the pre-expansion and static standing pretreatment is subjected to expansion suppression charging pretreatment, and charged to 1% SOC to 5% SOC. It can be understood that when the silicon-containing lithium-ion battery is charged to 1% SOC to 5% SOC, the expansion change value of the layer structure formed by the silicon-containing negative electrode slurry on the negative electrode sheet can be well controlled, and is relatively small. Thus, it ensures that the pulverization and cracking of the layer structure formed by the silicon-containing negative electrode slurry on the negative electrode sheet of the silicon-containing lithium-ion battery are effectively reduced under the condition of reduced energy consumption, and ensures the density and uniformity of the SEI film.

In one embodiment, the pre-pressurization and heating formation operation is performed on the pre-formed silicon-containing lithium-ion battery under a temperature of 35° C. to 80° C. It can be understood that in the pre-expansion and static standing pretreatment, the flowability of the electrolyte and the binder is effectively increased, and in combination with the pressure of F4, the plastic deformation of the layer structure formed by the negative electrode material is effectively achieved in advance; and in the expansion suppression charging pretreatment, the migration ability of lithium ions is effectively accelerated, thereby resulting in the rapid formation of the SEI film. In the liquid absorption and slow expansion static standing pretreatment, the redistribution of lithium ions is effectively accelerated, and the local stress concentration is effectively alleviated.

In one embodiment, the pre-formed silicon-containing lithium-ion battery is subjected to pre-expansion and static standing pretreatment under the pressure of F4, and the standing time is 5 minutes to 3 hours, which effectively ensures the full formation of a dense SEI film.

In one embodiment, the pre-formed silicon-containing lithium-ion battery after the expansion suppression charging pretreatment is subjected to liquid absorption and slow expansion standing pretreatment under the pressure of F6, and the standing time is 5 minutes to 3 hours, which effectively ensures the release of the expansion potential energy of the layer structure formed by the negative electrode slurry, the enhancement of the binding force of the binder to the silicon-carbon particles in the layer structure formed by the negative electrode slurry, the formation of buffer voids in the layer structure formed by the negative electrode slurry, and the uniform and full infiltration of the electrolyte into each part of the layer structure formed by the negative electrode slurry.

In one embodiment, F4, F5, and F6 are independently selected from 0.5 kgf/cm² to 5 kgf/cm².

In one embodiment, the areal density of the negative electrode slurry on one side of the negative electrode sheet is 1.8 mAh/cm² to 7 mAh/cm².

In one embodiment, the silicon-containing lithium-ion battery also includes a separator, which can be a polyethylene separator, a polypropylene separator, a polyolefin multi-layer composite film, a cellulose separator or a solid electrolyte separator. Further, the polyolefin multi-layer composite film is a polypropylene-polyethylene-polypropylene composite separator. Further, the separator can be a ceramic-coated separator, a polyvinylidene fluoride-coated separator, a polyacrylonitrile-coated separator, a polymethyl methacrylate-coated separator, a polyaramide-coated separator, a polyvinylidene fluoride-hexafluoropropylene copolymer-coated separator, a polyimide-coated separator, a polytetrafluoroethylene-coated separator or an aramid-coated separator.

In one of the embodiments, the density of the SEI film of the silicon-containing lithium-ion battery obtained through the formation method of the silicon-containing lithium-ion battery is greater than that of the SEI film of the silicon-containing lithium-ion battery obtained through the formation at constant temperature, constant pressure and small current. Further, the thickness of the SEI film of the silicon-containing lithium-ion battery obtained through the formation method of the silicon-containing lithium-ion battery is less than that of the SEI film of the silicon-containing lithium-ion battery obtained through the formation at constant temperature, constant pressure and small current.

The present application also provides a computer-readable storage medium which is configured to store a computer program or instructions. When the computer program or instructions are executed by a computing device, the formation method of the silicon-containing lithium-ion battery in any of the above embodiments can be carried out. Further, the computer-readable storage medium is not limited to store computer programs or instructions used for the formation of silicon-containing lithium-ion batteries, but can also be used alone to store computer programs or instructions for performing the following formation method which includes the following steps: obtaining a pre-formed lithium-ion battery; performing a pressurized heating formation operation on the pre-formed lithium-ion battery, wherein the pressurized heating formation operation on the pre-formed lithium-ion battery specifically includes the following operation steps: performing a pre-swelling and standing treatment on the pre-formed lithium-ion battery at F1 pressure; performing a swelling suppression and charging treatment on the pre-formed lithium-ion battery after the pre-swelling and standing treatment at F2 pressure; performing a liquid absorption and slow swelling standing treatment on the pre-formed lithium-ion battery after the swelling suppression and charging treatment at F3 pressure; where F1=F2, F3<F1. Further, the formation method of the silicon-containing lithium-ion battery at least includes the following operation steps: performing a pre-swelling and standing pretreatment on the pre-formed silicon-containing lithium-ion battery at F4 pressure; performing a swelling suppression and charging pretreatment on the pre-formed silicon-containing lithium-ion battery after the pre-swelling and standing pretreatment at F5 pressure; performing a liquid absorption and slow swelling standing pretreatment on the pre-formed silicon-containing lithium-ion battery after the swelling suppression and charging pretreatment at F6 pressure; where F4=F5, F6≤F4, F4<F1. Further, the formation method of the silicon-containing lithium-ion battery is used for the formation of silicon-containing lithium-ion batteries. Further, the silicon-containing lithium-ion battery at least includes an electrolyte and a negative electrode plate, the electrolyte is in contact with the negative electrode plate, at least one side of the negative electrode plate is coated with a negative electrode slurry, and the negative electrode slurry includes a silicon-based material and graphite, and the mass ratio of the silicon-based material to the graphite is 100:(0 to 534).

The present application also discloses a formation device for forming silicon-containing lithium-ion batteries. Further, the formation device is used to perform the formation method of the silicon-containing lithium-ion battery in any of the above embodiments. Further, the formation device is not limited to being used for forming silicon-containing lithium-ion batteries, but can also be used alone to form lithium-ion batteries, for performing the following formation method which includes the following steps: obtaining a pre-formed lithium-ion battery; performing a pressurized heating formation operation on the pre-formed lithium-ion battery, wherein the pressurized heating formation operation on the pre-formed lithium-ion battery specifically includes the following operation steps: performing a pre-swelling and standing treatment on the pre-formed lithium-ion battery at the pressure of F1; performing a swelling suppression and charging treatment on the pre-formed lithium-ion battery after the pre-swelling and standing treatment at the pressure of F2; performing a liquid absorption and slow swelling standing treatment on the pre-formed lithium-ion battery after the swelling suppression and charging treatment at the pressure of F3; where F1=F2 and F3<F1. Further, the formation method of the silicon-containing lithium-ion battery at least includes the following operation steps: performing a pre-swelling and standing pretreatment on the pre-formed silicon-containing lithium-ion battery at the pressure of F4; performing a swelling suppression and charging pretreatment on the pre-formed silicon-containing lithium-ion battery after the pre-swelling and standing pretreatment at the pressure of F5; performing a liquid absorption and slow swelling standing pretreatment on the pre-formed silicon-containing lithium-ion battery after the swelling suppression and charging pretreatment at the pressure of F6; where F4=F5, F6≤F4 and F4<F1. Further, the formation method of the silicon-containing lithium-ion battery is used for the formation of silicon-containing lithium-ion batteries. Further, the silicon-containing lithium-ion battery at least comprises an electrolyte and a negative electrode sheet, the electrolyte is in contact with the negative electrode sheet, at least one side of the negative electrode sheet is coated with a negative electrode slurry, the negative electrode slurry includes silicon-based material and graphite, and the mass ratio of the silicon-based material to the graphite is 100:(0˜534).

The following are some specific embodiments. If % is mentioned, it indicates by weight percentage. It should be noted that the embodiments below do not list all possible embodiments. Moreover, unless otherwise specified, the materials used in the embodiments below can all be obtained commercially.

### Embodiment 1

### Preparation of Conductive Adhesive

Material Preparation: Prepare materials according to the composition of each group of the conductive adhesives listed as shown in Table 1.

Mixing: Mix the binder and solvent at a stirring speed of 1000 r/min for 180 minutes to obtain a gel-containing solvent. Then add the tubular conductive substance to the gel-containing solvent and mix at a stirring speed of 2100 r/min for 60 minutes. Next, add the conductive fiber transition substance to the gel-containing solvent and mix at a stirring speed of 1800 r/min for 30 minutes. Finally, add the conductive spherical node substance and mix at a stirring speed of 2100 r/min for 120 minutes.

### Embodiment 2

### Preparation of Electrode Slurry

Material Preparation: Prepare materials according to the compositions of each group of electrode slurry listed in Table 2.

Mix all compositions of the electrode slurry with a stirring speed of 1500-2100 r/min for a total of 5 hours. Then, under a stirring speed of 5 rpm, perform vacuuming at a vacuum degree gradient change rate of −1 kPa/s until it reaches −90 kPa. Next, fill in gas at a vacuum degree change rate of −1 kPa/s until it reaches −40 kPa. Repeat the steps of vacuuming and filling in gas 30 times. The viscosity of the positive electrode slurry is controlled at 7000 mPa·s, and that of the negative electrode slurry is controlled at 2500 Pa·s.

### Embodiment 3

### Preparation of Electrode Slurry

Material Preparation: Prepare materials according to the components of each group of electrode slurries as shown in Table 2.

Mix all compositions of the electrode slurry with a stirring speed of 1500-2100 r/min for a total of 5 hours. Then, under a stirring speed of 5 rpm, perform vacuuming at a vacuum degree gradient change rate of −5 kPa/s until it reaches −90 kPa. Next, fill in gas at a vacuum degree change rate of −5 kPa/s until it reaches −40 kPa. Repeat the steps of vacuuming and filling in gas 20 times. The viscosity of the positive electrode slurry is controlled at 7000 mPa·s, and that of the negative electrode slurry is controlled at 2500 mPa·s.

### Embodiment 4

### Preparation of Electrode Slurry

Material Preparation: Prepare materials according to the components of each group of electrode slurries as shown in Table 2.

Mix all components of the electrode slurry at a stirring speed of 1500-2100 r/min for a total of 5 hours. Then, under a stirring speed of 5 rpm, perform vacuuming at a vacuum degree gradient change rate of −9 kPa/s until it reaches −90 kPa. Next, fill in gas at a vacuum degree change rate of −9 kPa/s until it reaches −40 kPa. Repeat the steps of vacuuming and filling in gas 40 times. The viscosity of the positive electrode slurry is controlled at 7000 mPa·s, and that of the negative electrode slurry is controlled at 2500 mPa·s.

### Embodiment 5

### Preparation of Electrode Slurry

Material Preparation: Prepare materials according to the components of each group of the electrode slurry as shown in Table 2.

Mix all components of the electrode slurry at a stirring speed of 1500-2100 r/min for a total of 5 hours. Then, under a stirring speed of 5 rpm, perform vacuuming, reduce the pressure at a vacuum degree gradient change rate of −5 kPa/s to −110 kPa. Subsequently, fill gas to increase the pressure to −60 kPa at a vacuum degree gradient change rate of −5 kPa/s. Repeat the steps of vacuuming and filling in gas 20 times. The viscosity of the positive electrode slurry is controlled at 7000 mPa·s, and that of the negative electrode slurry is controlled at 2500 mPa·s.

### Embodiment 6

A pre-formed silicon-containing lithium-ion battery was made by a preparation method for producing silicon-containing lithium-ion batteries, wherein the preparation methods for the positive electrode and negative electrode slurries correspond to group C1 in Table 3.

Maintain a constant temperature of 35° C. Under a pressure of 4 kgf/cm², let the pre-formed lithium-ion battery stand for 15 minutes. Then, under a pressure of 4 kgf/cm², charge the pre-formed lithium-ion battery at 0.05 C for 312 minutes. Subsequently, under a pressure of 2 kgf/cm², let the pre-formed lithium-ion battery stand for 15 minutes; repeat the steps twice to obtain the silicon-containing lithium-ion battery.

### Embodiment 7

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 4 kgf/cm², let the pre-formed silicon-containing lithium-ion battery stand for 15 minutes. Then, under a pressure of 4 kgf/cm², charge the pre-formed lithium-ion battery at 0.05 C for 156 minutes. Subsequently, under a pressure of 2 kgf/cm², let the battery stand for 15 minutes. Repeat the steps four times to obtain the silicon-containing lithium-ion battery.

### Embodiment 8

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 4 kgf/cm², let the pre-formed silicon-containing lithium-ion battery stand for 15 minutes. Then, under a pressure of 4 kgf/cm², charge the battery at 0.05 C for 104 minutes. Subsequently, under a pressure of 2 kgf/cm², let the pre-formed silicon-containing lithium-ion battery stand for 15 minutes. Repeat the steps seven times to obtain the silicon-containing lithium-ion battery.

### Embodiment 9

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 2 kgf/cm², let the battery stand for 15 minutes. Then, under a pressure of 2 kgf/cm², charge the battery at 0.05 C for 156 minutes. Subsequently, under a pressure of 1 kgf/cm², let the battery stand for 15 minutes. Repeat the above steps four times to obtain the silicon-containing lithium-ion battery.

### Embodiment 10

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 8 kgf/cm², let the pre-formed silicon-containing lithium-ion battery stand for 15 minutes. Then, under a pressure of 8 kgf/cm², charge the battery at 0.05 C for 156 minutes. Subsequently, under a pressure of 4 kgf/cm², let the pre-formed silicon-containing lithium-ion battery stand for 15 minutes. Repeat the steps four times to obtain the silicon-containing lithium-ion battery.

### Embodiment 11

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Perform a pre-formation treatment on the pre-formed silicon-containing lithium-ion battery. The pre-formation treatment includes: under a pressure of 1 kgf/cm², let the pre-formed silicon-containing lithium-ion battery stand for 1 hour. Then, under a pressure of 1 kgf/cm², charge the pre-formed silicon-containing lithium-ion battery at 0.02 C to 2% SOC. Subsequently, under a pressure of 0.5 kgf/cm², let the pre-formed silicon-containing lithium-ion battery stand for 15 minutes.

Further formation is performed on the silicon-containing lithium-ion battery which has been subjected to the pre-formation treatment. Maintain a constant temperature of 35° C. Under a pressure of 4 kgf/cm², let the battery stand for 15 minutes. Then, under a pressure of 4 kgf/cm², charge the pre-formed silicon-containing lithium-ion battery at 0.05 C for 150 minutes. Subsequently, under a pressure of 2 kgf/cm², let the pre-formed silicon-containing lithium-ion battery stand for 15 minutes. Repeat the above steps four times to obtain the silicon-containing lithium-ion battery.

### Embodiment 12

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Perform a pre-formation treatment on the battery: Under a pressure of 4 kgf/cm², let the pre-formed silicon-containing lithium-ion battery stand for 1 hour. Then, under a pressure of 4 kgf/cm², charge the pre-formed silicon-containing lithium-ion battery at 0.02 C to 2% SOC. Subsequently, under a pressure of 2 kgf/cm², let the pre-formed silicon-containing lithium-ion battery stand for 15 minutes.

Further formation is performed on the pre-formed silicon-containing lithium-ion battery which has been subjected to the pre-formation treatment. Maintain a constant temperature of 35° C. Under a pressure of 8 kgf/cm², let the pre-formed silicon-containing lithium-ion battery stand for 15 minutes. Then, under a pressure of 8 kgf/cm², charge the pre-formed silicon-containing lithium-ion battery at 0.05 C for 150 minutes. Subsequently, under a pressure of 4 kgf/cm², let the pre-formed silicon-containing lithium-ion battery stand for 15 minutes. Repeat the above steps four times to obtain the silicon-containing lithium-ion battery.

### Embodiment 13

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 80° C. Under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.05 C for 156 minutes. Subsequently, under a pressure of 2 kgf/cm², let the pre-formed silicon-containing lithium-ion battery stand for 15 minutes. Repeat the above steps four times to obtain the silicon-containing lithium-ion battery.

### Embodiment 14

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C., under a pressure of 4 kgf/cm², let the pre-formed silicon-containing lithium-ion battery stand for 15 minutes. Then, under the pressure of 4 kgf/cm², charge the pre-formed silicon-containing lithium-ion battery at 0.5° C. for 39 minutes. Subsequently, under a pressure of 2 kgf/cm², let the battery stand for 15 minutes. Repeat the above steps four times to obtain the silicon-containing lithium-ion battery.

### Embodiment 15

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C., under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.01 C for 780 minutes. Subsequently, under a pressure of 2 kgf/cm², let the battery stand for 15 minutes. Repeat the above steps four times to obtain the silicon-containing lithium-ion battery.

### Embodiment 16

A pre-formed silicon-containing lithium-ion battery was prepared using the method for producing silicon-containing lithium-ion batteries, wherein the preparation methods for the positive electrode and negative electrode slurries correspond to group C2 in Table 3.

Maintain a constant temperature of 35° C. Under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.05 C for 156 minutes. Subsequently, under a pressure of 2 kgf/cm², let the pre-formed silicon-containing lithium-ion battery stand for 15 minutes. Repeat the steps four times to obtain the silicon-containing lithium-ion battery.

### Embodiment 17

A pre-formed silicon-containing lithium-ion battery was prepared using the method for producing silicon-containing lithium-ion batteries, wherein the preparation methods for the positive electrode and negative electrode slurries correspond to group C3 in Table 3.

Maintain a constant temperature of 35° C., under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.05 C for 156 minutes. Subsequently, under a pressure of 2 kgf/cm², let the pre-formed silicon-containing lithium-ion battery stand for 15 minutes. Repeat the above steps four times to obtain the silicon-containing lithium-ion battery.

### Comparative Example 1

### Preparation of Electrode Slurry

Material Preparation: Prepare materials according to the components of the electrode slurry listed in Table 2 for each group.

Mix all components of the electrode slurry at a stirring speed of 1500-2100 r/min for a total of 5 hours. Then, under a stirring speed of 5 rpm, apply vacuum to −90 kPa and maintain for 60 minutes. The viscosity of the positive electrode slurry is controlled at 7000 mPa·s, and the negative electrode slurry at 2500 mPa·s.

### Comparative Example 2

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C., under a pressure of 2 kgf/cm², let the pre-formed silicon-containing lithium-ion battery stand for 1 hour. Then, under a pressure of 2 kgf/cm², charge the pre-formed silicon-containing lithium-ion battery at 0.05 C for 120 minutes to 10% SOC. Subsequently, under a pressure of 4 kgf/cm², let the pre-formed silicon-containing lithium-ion battery stand for 15 minutes. Then, under a pressure of 4 kgf/cm², charge the battery at 0.1 C for 120 minutes to 30% SOC. Subsequently, under a pressure of 6 kgf/cm², let the pre-formed silicon-containing lithium-ion battery stand for 15 minutes. Then, under a pressure of 6 kgf/cm², charge the pre-formed silicon-containing lithium-ion battery at 0.2 C for 66 minutes to 52% SOC to obtain the silicon-containing lithium-ion battery.

### Comparative Example 3

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C., under a pressure of 2 kgf/cm², let the pre-formed silicon-containing lithium-ion battery stand for 1 hour. Then, under a pressure of 2 kgf/cm², charge the pre-formed silicon-containing lithium-ion battery at 0.05 C for 120 minutes to 10% SOC. Subsequently, under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.05 C for 240 minutes to 30% SOC. Subsequently, under a pressure of 6 kgf/cm², let the pre-formed silicon-containing lithium-ion battery stand for 15 minutes. Then, under a pressure of 6 kgf/cm², charge the pre-formed silicon-containing lithium-ion battery at 0.1 C for 132 minutes to 52% SOC to obtain the silicon-containing lithium-ion battery.

### Comparative Example 4

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C., under a pressure of 2 kgf/cm², let the pre-formed silicon-containing lithium-ion battery stand for 1 hour; then, under a pressure of 2 kgf/cm², charge the battery at 0.05 C for 120 minutes to 10% SOC. Subsequently, under a pressure of 2 kgf/cm², let the pre-formed silicon-containing lithium-ion battery stand for 15 minutes. Then, under a pressure of 2 kgf/cm², charge the battery at 0.1 C for 120 minutes to 30% SOC. Subsequently, under a pressure of 2 kgf/cm², let the pre-formed silicon-containing lithium-ion battery stand for 15 minutes. Then, under a pressure of 2 kgf/cm², charge the pre-formed silicon-containing lithium-ion battery at 0.2 C for 66 minutes to 52% SOC to obtain the silicon-containing lithium-ion battery.

### Comparative Example 5

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 2 kgf/cm², let the silicon-containing lithium-ion battery stand for 1 hour. Then, under a pressure of 2 kgf/cm², charge the silicon-containing lithium-ion battery at 0.05 C for 120 minutes to 10% SOC. Subsequently, under a pressure of 2 kgf/cm², let the silicon-containing lithium-ion battery stand for 15 minutes. Then, under a pressure of 2 kgf/cm², charge the silicon-containing lithium-ion battery at 0.05 C for 240 minutes to 30% SOC. Subsequently, under a pressure of 2 kgf/cm², let the battery stand for 15 minutes. Then, under a pressure of 2 kgf/cm², charge the silicon-containing lithium-ion battery at 0.1 C for 132 minutes to 52% SOC to obtain the silicon-containing lithium-ion battery.

### Comparative Example 6

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 6 kgf/cm², let the pre-formed silicon-containing lithium-ion battery stand for 1 hour. Then, under a pressure of 6 kgf/cm², charge the battery at 0.05 C for 120 minutes to 10% SOC. Subsequently, under a pressure of 4 kgf/cm², let the pre-formed silicon-containing lithium-ion battery stand for 15 minutes. Then, under a pressure of 4 kgf/cm², charge the battery at 0.1 C for 120 minutes to 30% SOC. Subsequently, under a pressure of 2 kgf/cm², let the pre-formed silicon-containing lithium-ion battery stand for 15 minutes. Then, under a pressure of 2 kgf/cm², charge the pre-formed silicon-containing lithium-ion battery at 0.2 C for 66 minutes to 52% SOC to obtain the silicon-containing lithium-ion battery.

### Comparative Example 7

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 6 kgf/cm², let the pre-formed silicon-containing lithium-ion battery stand for 1 hour. Then, under a pressure of 6 kgf/cm², charge the pre-formed silicon-containing lithium-ion battery at 0.05 C for 120 minutes to 10% SOC. Subsequently, under a pressure of 4 kgf/cm², let the pre-formed silicon-containing lithium-ion battery stand for 15 minutes. Then, under a pressure of 4 kgf/cm², charge the pre-formed silicon-containing lithium-ion battery at 0.05 C for 240 minutes to 30% SOC. Subsequently, under a pressure of 2 kgf/cm², let the battery stand for 15 minutes. Then, under a pressure of 2 kgf/cm², charge the pre-formed silicon-containing lithium-ion battery at 0.1 C for 132 minutes to 52% SOC to obtain the silicon-containing lithium-ion battery.

### Comparative Example 8

A pre-formed silicon-containing lithium-ion battery was prepared using the method for producing silicon-containing lithium-ion batteries, wherein the preparation methods for the positive electrode and negative electrode slurries correspond to group C1 in Table 3.

Maintain a constant temperature of 35° C. Under a pressure of 4 kgf/cm², charge the pre-formed silicon-containing lithium-ion battery at 0.05 C for 156 minutes. Subsequently, under a pressure of 2 kgf/cm², charge the pre-formed silicon-containing lithium-ion battery at 0.05 C for 156 minutes. Repeat the above steps twice to obtain the silicon-containing lithium-ion battery.

TABLE 1
Composition of Conductive Adhesive

| | Composition | | | | |
|---|---|---|---|---|---|
| | | | | | conductive |
| | | | tubular | | spherical |
| | | | conductive | Conductive | node |
| group | binder | Solvent | substance | fiber | substance |
| a1 | PVDF1.5% | NMP100% | SWCNT0.2% | VGCF1.0% | SP3.0% |
| a2 | PVDF1.5% | NMP100% | SWCNT0.2% | VGCF1.0% | AB3.0% |
| a3 | PVDF1.5% | NMP100% | SWCNT0.2% | VGCF1.0% | AC3.0% |
| a4 | PVDF1.5% | NMP100% | SWCNT0.2% | VGCF1.0% | KB3.0% |
| a5 | PVDF1.5% | NMP100% | FWCNT | VGCF1.0% | SP3.0% |
| | | | 0.2% | | |
| a6 | CMC = 0.6% | Water | SWCNT0.2% | VGCF1.0% | SP3.0% |
| | | 100% | | | |
| a7 | CMC = 0.6% | Water | FWCNT | VGCF1.0% | SP3.0% |
| | | 100% | 0.2% | | |

TABLE 2
Composition of Electrode Slurry

| | Composition | | | |
|---|---|---|---|---|
| | | Conductive | | |
| group | Active substance | Adhesive | Binder | Solvent |
| b1 | Lithium Cobalt Oxide | Group a1 | total amount | total amount |
| | Positive electrode | | of PVDF: | of NMP: |
| | Material 96.4% | | 1.5% | 50% |
| b2 | Lithium Cobalt Oxide | Group a5 | total amount | total amount |
| | Positive electrode | | of PVDF: | of NMP: |
| | Material 96.4% | | 1.5% | 50% |
| b3 | Si—C Negative | Group a6 | total amount | total amount |
| | electrode Material | | of CMC: | of Water: |
| | (Si content | | 1.5% | 120% |
| | 51%):Graphite = | | total amount | |
| | 1:4, Total 94.95% | | of SBR: | |
| | | | 1.5% | |
| b4 | Si—C Negative | Group a7 | total amount | total amount |
| | electrode Material | | of CMC: | of Water: |
| | (Si content | | 0.5% | 120% |
| | 51%):Graphite = | | total amount | |
| | 1:4, Total 95.45% | | of PAA: | |
| | | | 2.0% | |
| b5 | Graphite Negative | Group a6 | total amount | total amount |
| | electrode Material | | of CMC: | of Water: |
| | 94.95% | | 1.5% | 120% |
| | | | total amount | |
| | | | of SBR: | |
| | | | 1.5% | |

The method for preparing lithium batteries is as follows:
Preparing positive electrode Slurry;
Preparing negative electrode Slurry;
Coating and Drying: the electrode slurries are uniformly coated onto copper/aluminum foil current collectors by using an extrusion coater; the coated electrode sheets are dried in an oven to remove the solvent.

Rolling and Die-Cutting: the dried electrode sheets are pressed to increase the density and adhesion of the electrode; the electrode sheets are cut into appropriate sizes and shapes by using a punching machine.

Stacking: the silicon-carbon negative electrode sheets, separator, and positive electrode sheets are stacked in sequence to form a bare cell.

Tab Welding: Al/Ni tabs are welded to the positive/negative current collectors.

Housing/Encapsulation: the bare cell is placed into an aluminum-plastic film pouch with a pre-formed cavity. The top side is sealed, leaving an electrolyte injection port.

Electrolyte Injection and Standing: A precisely measured amount of electrolyte is injected into the housing through the port in a dry room, followed by sealing the port. The battery is left to stand at room temperature or elevated temperature to allow the electrolyte to wet the electrodes and the separator.

The preparation methods for the positive electrode and negative electrode slurries are shown in Table 3:

TABLE 3
Electrode Slurry

| group | Positive electrode Slurry | Negative electrode Slurry |
|---|---|---|
| c1 | Positive electrode slurry | Negative electrode slurry is |
| | preparation: Lithium cobalt | prepared using material as |
| | oxide positive electrode | shown in Group b3 and by the |
| | material, conductive carbon | method of Embodiment 3. The |
| | black, and PVDF are mixed in a | areal density of the negative |
| | mass ratio of 96:2.5:1.5. The | electrode slurry on one side of |
| | mixture is blended with NMP | the negative electrode is 3 |
| | solvent to form a uniform slurry | mAh/cm², and the areal density |
| | with a viscosity of 6000 | on both sides is 6 mAh/cm². |
| | mPa · s and a solid content | |
| | of 73%. | |
| c2 | Positive electrode slurry | Negative electrode slurry is |
| | preparation: Lithium cobalt | prepared using material as |
| | oxide positive electrode | shown in Group b4 and by the |
| | material, conductive carbon | method of Embodiment 3. The |
| | black, and PVDF are mixed in a | areal density of the negative |
| | mass ratio of 96:2.5:1.5. The | electrode slurry on one side is |
| | mixture is blended with NMP | 3 mAh/cm², and the areal |
| | solvent to form a uniform slurry | density on both sides is |
| | with a viscosity of 6000 | 6 mAh/cm². |
| | mPa · s and a solid content | |
| | of 73%. | |
| c3 | Positive electrode slurry is | Negative electrode slurry is |
| | prepared using material as | prepared using material as |
| | shown in Group b1 and by the | shown in Group b3 and by the |
| | method of Example 3. | method of Embodiment 3. The |
| | | areal density of the negative |
| | | electrode slurry on one side of |
| | | the negative electrode is 3 |
| | | mAh/cm², and the areal density |
| | | on both sides is 6 mAh/cm². |

The specific parameters involved in the above lithium battery preparation methods are conventional settings for conventional lithium battery manufacturing processes and will not be described here.

The surface observation results for the electrode slurries obtained in Examples 2 to 5 and the corresponding conductive adhesive-containing electrode sheets after coating and drying are shown in Table 4:

TABLE 4

| | | | Coating Appearance |
|---|---|---|---|
| | Visual Slurry | Visual Coating | Under4.5x |
| group | Appearance | Appearance | Microscope |
| Embodiment 2 | No bubbles | no pits | smooth surface, |
| (b1~b5) | | | no pits, no pinholes |
| Embodiment 3 | No bubbles | no pits | smooth surface, |
| (b1~b5) | | | no pits, no pinholes |
| Embodiment 4 | No bubbles | no pits | smooth surface, |
| (b1~b5) | | | no pits, no pinholes |
| Embodiment 5 | No bubbles | no pits | smooth surface, |
| (b1~b5) | | | no pits, no pinholes |
| Comp. Example. 1 | Bubbles | Pits and | pinholes, pits, and |
| (b1~b5) | present | depressions | depressions on |
| | | | surface |

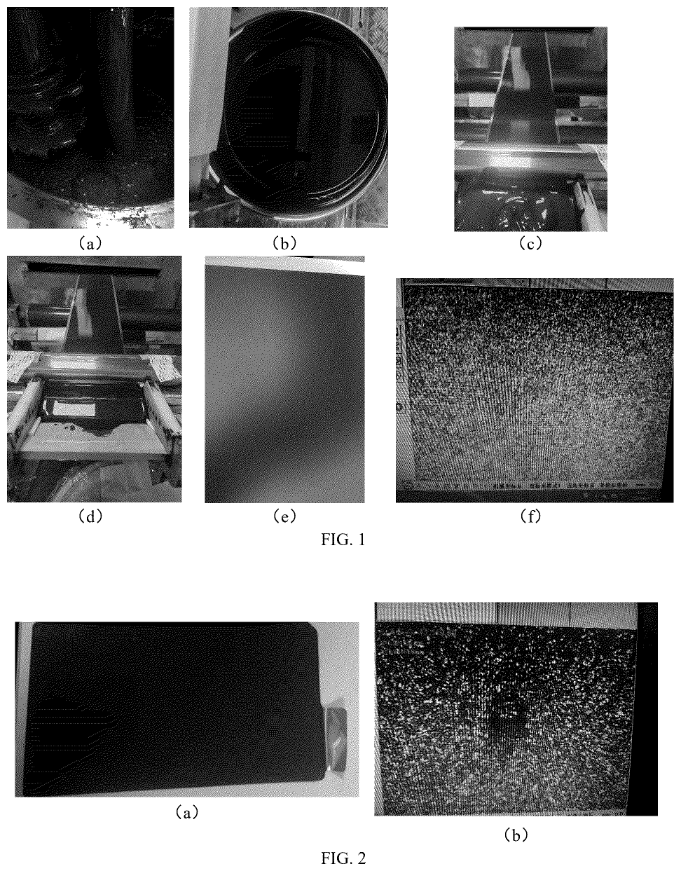

FIGS. 1(a)˜1(f) show the negative electrode slurry prepared using material of Group b3 and by the method of Example 3 and the corresponding negative electrode sheet after coating and drying. FIGS. 2(a) and 2(b) show the negative electrode sheet prepared using material of Group b3 and by the method of Comparative Example 1 after coating and drying. Referring to Table 4, it can be known that the electrode slurries obtained in Examples 3 to 5 are free of bubbles, and after coating and drying, the corresponding electrode coatings containing conductive adhesive show no pits. Especially under 4.5× microscope, the coating surface is smooth, without pits or pinholes. In contrast, the electrode slurry obtained in Comparative Example 1 contains bubbles, and after coating and drying, the corresponding electrode coatings containing conductive adhesive exhibit pits and depressions. Under 4.5× microscope, the coating surface shows pinholes, pits, and depressions.

The silicon-containing lithium-ion batteries obtained in Examples 6 to 17 and Comparative Examples 2 to 8 were tested, and the results are shown in Table 5:

TABLE 5
Electrical Performance of Silicon-containing Lithium-ion Batteries

| | | | | 250-Cycle |
|---|---|---|---|---|
| | 0.2 C | Discharge | Internal | Capacity |
| | Capacity | Energy | Resistance | Retention |
| Group | (mAh) | (Wh) | (Ω) | Rate (%) |
| Embodiment 6 | 8884.5 | 31.59 | 2.60 | 94.83 |
| Embodiment 7 | 9065.4 | 32.29 | 2.53 | 97.64 |
| Embodiment 8 | 9099.9 | 32.40 | 2.57 | 97.41 |
| Embodiment 9 | 8949.4 | 31.89 | 2.60 | 94.89 |
| Embodiment 10 | 9017.2 | 32.12 | 2.57 | 95.70 |
| Embodiment 11 | 9119.0 | 32.50 | 2.43 | 96.01 |
| Embodiment 12 | 9096.4 | 32.42 | 2.41 | 96.41 |
| Embodiment 13 | 9028.0 | 32.11 | 2.60 | 94.88 |
| Embodiment 14 | 9008.4 | 32.07 | 2.58 | 95.74 |
| Embodiment 15 | 9014.4 | 32.06 | 2.65 | 95.74 |
| Embodiment 16 | 9053.2 | 32.63 | 2.33 | 95.17 |
| Embodiment 17 | 8865.4 | 31.20 | 2.71 | 98.05 |
| Comp. Ex. 2 | 8610.3 | 30.64 | 3.09 | 89.8 |
| Comp. Ex. 3 | 8626.2 | 30.45 | 3.21 | 87.98 |
| Comp. Ex. 4 | 8526.4 | 30.13 | 3.54 | 90.01 |
| Comp. Ex. 5 | 8537.2 | 30.14 | 3.54 | 89.41 |
| Comp. Ex. 6 | 8332.5 | 29.57 | 3.08 | 84.53 |
| Comp. Ex. 7 | 8325.1 | 29.30 | 3.79 | 80.81 |
| Comp. Ex. 8 | 8884.5 | 31.46 | 2.80 | 91.32 |

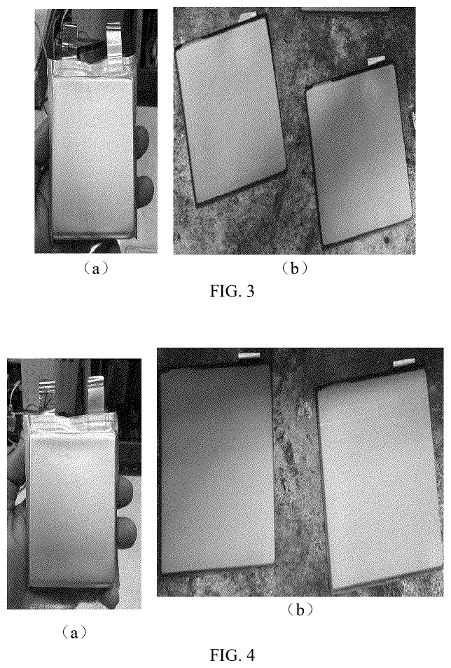

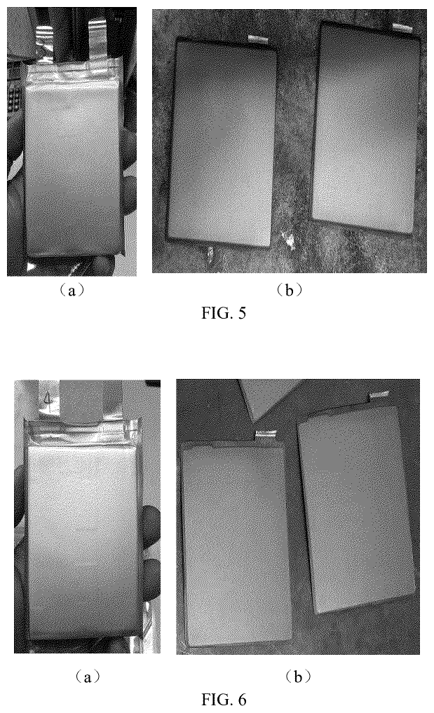

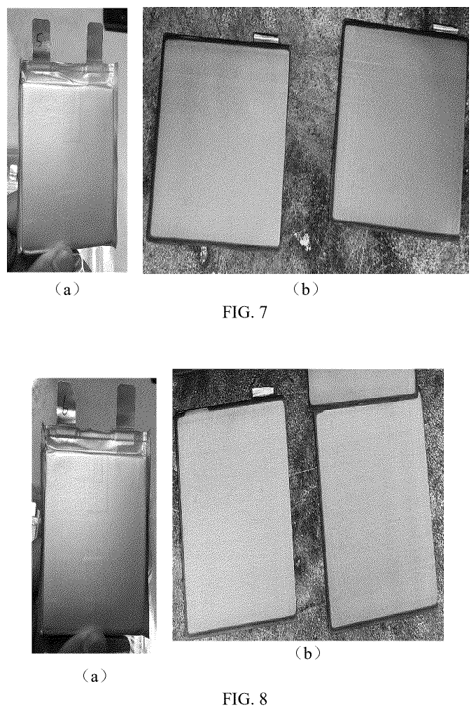

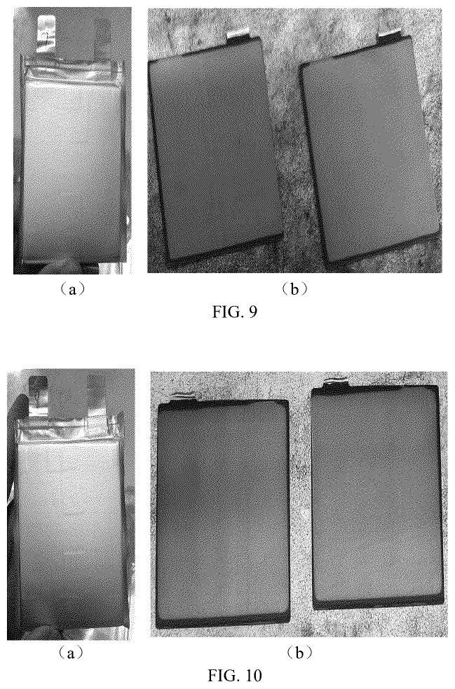

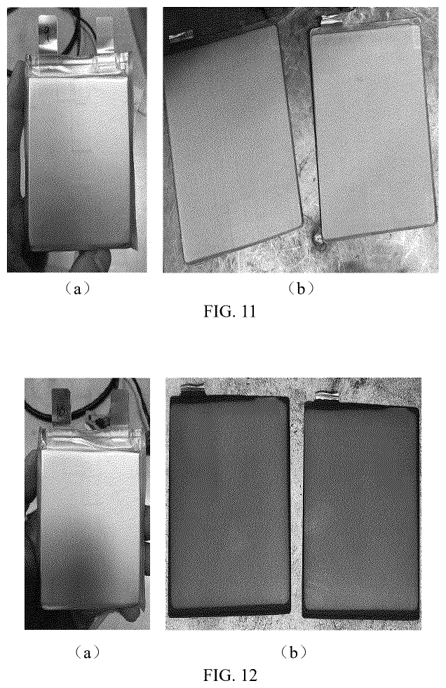

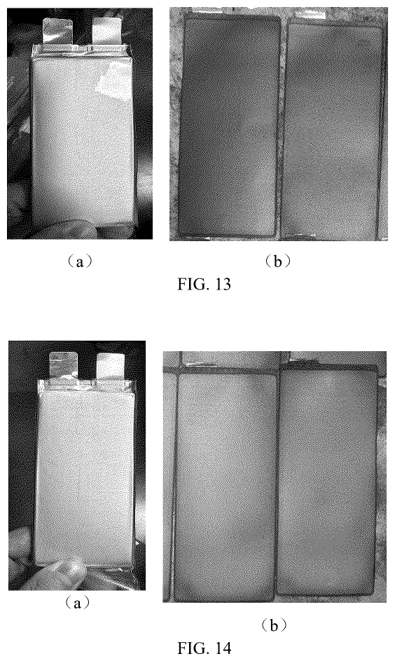

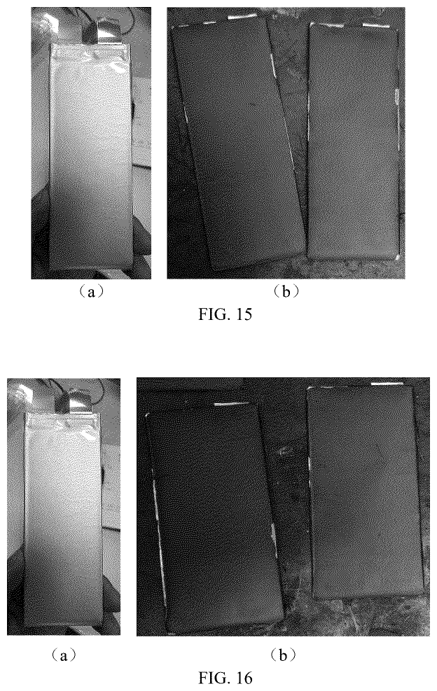

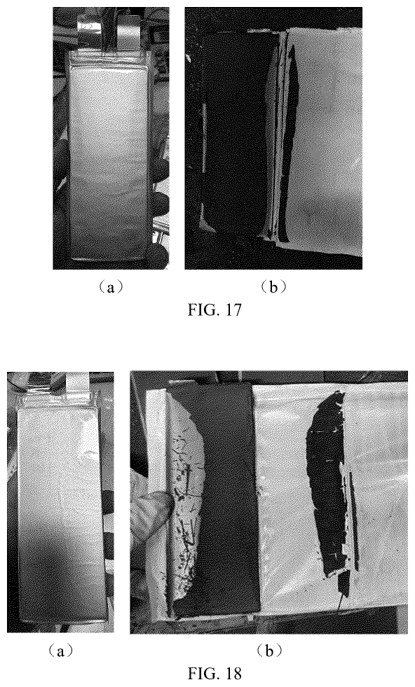

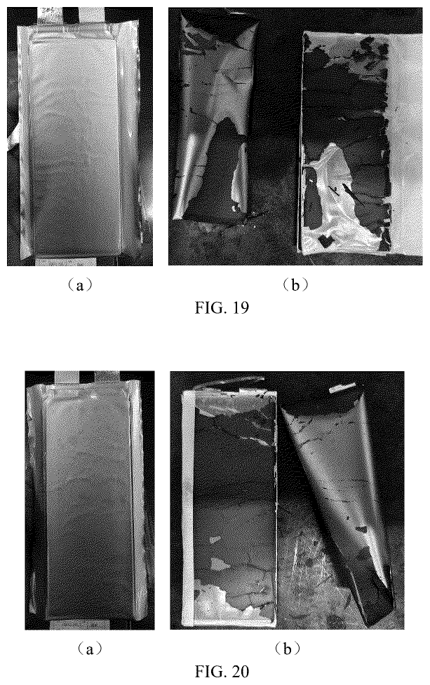

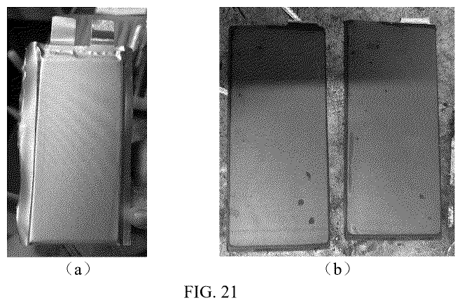

FIGS. 3(a) to 21(b) show the silicon-containing lithium-ion batteries after formation according to Embodiments 6 to 17 and Comparative Examples 2 to 8 respectively, wherein FIGS. (3˜21)(a) are photos of the fully charged cell and (3˜21)(b) are photos of the negative electrode sheet after being discharged. Referring also to Table 5, it can be seen that the electrochemical performance of the silicon-containing lithium-ion batteries from Embodiments 6 to 17 is excellent, with no pulverization or cracking. In contrast, the electrochemical performance of the silicon-containing lithium-ion batteries from Comparative Examples 2 to 8 is relatively poor, with slight or severe pulverization and cracking.

Cases listed above only express some implementation methods of this invention, their descriptions are specific and detailed, but it shall not be deemed as limits to patent scope of the invention. It is necessary to point out that ordinary technicians in the field can make some transformations and improvements without separating from this invention thinking, all these belong to protection scope of this invention. Therefore, the protection scope of this invention shall refer to requirements in the attached claims.

1. A conductive adhesive being consisted of:
binder;
solvent; and
conductive agent, wherein the conductive agent is consisted of conductive spherical node substance, conductive fiber transition substance and tubular conductive substance;
wherein the conductive spherical node substance is at least one of carbon back, furnace black, acetylene black and Ketjen black;
wherein the conductive fiber transition substance is carbon fiber; and
wherein the tubular conductive substance is single-walled carbon nanotube and/or few-walled carbon nanotube.

2. The conductive adhesive according to claim 1, wherein the binder is a negative electrode binder or a positive electrode binder; and/or
the solvent is NMP (N-methyl-2-pyrrolidone) or water; and/or
a mass ratio of the conductive spherical node substance, the conductive fiber transition substance, and the tubular conductive substance is (0.5-4):(0.1-2):(0.02-1).

3. A preparation method for making the conductive adhesive according to claim 1, the preparation method comprising the following steps:
performing a first mixing operation on binder and solvent so as to obtain a gel-containing solvent;
adding the tubular conductive substance to the gel-containing solvent and perform a second mixing operation;
adding the conductive fiber transition substance to the gel-containing solvent which has been subjected to the second mixing operation and perform a third mixing operation; and
adding the conductive spherical node substance to the gel-containing solvent which has been subjected to the third mixing operation and perform a fourth mixing operation.

4. A slurry, including an active substance, a slurry-forming binder, and a slurry-forming solvent and the conductive adhesive according to claim 1.

5. The slurry according to claim 4, wherein the active substance is a positive electrode active substance or a negative electrode active substance; and/or,
the slurry-forming binder is at least one of PVDF (polyvinylidene fluoride), PTFE (polytetrafluoroethylene), CMC (carboxymethyl cellulose), SBR (styrene-butadiene rubber), and PAA (polyacrylic acid); and/or,
the slurry-forming solvent is water or NMP.

6. A preparation method for making the slurry according to claim 4, the preparation method comprising the following steps:
mixing the active substance, the slurry-forming binder, the slurry-forming solvent, and the conductive adhesive to obtain a mixed slurry; and
performing a debubbling operation on the mixed slurry, wherein the debubbling operation comprises:
performing a first debubbling treatment on the mixed slurry under a vacuum degree of P1; and
performing a second debubbling treatment on the mixed slurry under another vacuum degree of P2 after the first debubbling treatment;
wherein
$$P 1 < 0 , P 2 < 0 , and P 1 < P 2.$$

7. The preparation method according to claim 6, wherein P1 is selected from a range of −90 kPa to −110 kPa; and P2 is selected from a range of −40 kPa to −60 kPa; and/or
the debubbling operation is performed under a stirring condition and at a temperature of 10° C. to 45° C.; and/or
the debubbling operation is repeated for more than 20 cycles; and/or
the first debubbling treatment is performed after a pressure value of a container in which the mixed slurry is contained, is reduced to PI at a rate of −1 kPa/s to −9 kPa/s; and/or
the second debubbling treatment is performed after the pressure value of the container is increased to P2 at another rate of −1 kPa/s to −9 kPa/s.

8. A computer-readable storage medium storing a computer program or instructions for being executed to perform the preparation method of claim 6.

9. A silicon-containing lithium-ion battery, comprising an electrolyte and a negative electrode sheet in contact with the electrolyte, wherein at least one side of the negative electrode sheet is coated with a negative electrode slurry which comprises a silicon-based material, graphite, and the slurry according to claim 6, wherein a mass ratio of the silicon-based material to the graphite is 100:(0˜534).

10. A formation method for making the silicon-containing lithium-ion battery of claim 9, the formation method comprising the following steps:
obtaining a pre-formed silicon-containing lithium-ion battery;
performing a pressurized heating formation operation on the pre-formed silicon-containing lithium-ion battery, wherein the pressurized heating formation operation specifically comprises the following steps:
performing a pre-swelling standing treatment on the pre-formed silicon-containing lithium-ion battery under a pressure of F1;
performing a swelling-suppression charging treatment on the pre-formed silicon-containing lithium-ion battery under a pressure F2 after the pre-swelling standing treatment;
performing a liquid absorption and slow-swelling standing treatment on the pre-formed silicon-containing lithium-ion battery under a pressure of F3 after the swelling-suppression charging treatment;
wherein
$$F 1 = F 2 and F 3 < F 1 .$$

11. The formation method according to claim 10, wherein the pressurized heating formation operation is performed at a temperature of 35° C. to 80° C.; and/or
the swelling-suppression charging treatment is performed at a current of 0.01 C to 0.5 C; and/or
the pre-swelling standing treatment under a pressure of F1 comprises standing for 5 min to 3 h; and/or
the swelling-suppression charging treatment under a pressure of F2 comprises charging for 0.5 h to 10 h; and/or
the liquid absorption and slow-swelling standing treatment under a pressure of F3 comprises standing for 5 min to 3 h.

12. The formation method according to claim 10, wherein the pressurized heating formation operation is repeated at least twice; and/or
F1 and F2 each are independently selected from 2 kgf/cm² to 10 kgf/cm²; and/or
F3 is selected from 0.5 kgf/cm² to 5 kgf/cm².

13. The formation method according to claim 10, wherein the negative electrode slurry has an areal density of 1.8 mAh/cm² to 7 mAh/cm².

14. The formation method according to claim 10, wherein the silicon-containing lithium-ion battery further comprises a separator which is a polyethylene separator, polypropylene separator, polyolefin multilayer composite membrane, cellulose separator, or solid-state electrolyte separator.

15. The formation method according to claim 10, wherein after the step of obtaining the pre-formed silicon-containing lithium-ion battery and before the step of performing the pressurized heating formation operation on the pre-formed silicon-containing lithium-ion battery, the formation method further comprises:
performing a pre-pressurization heating formation operation on the pre-formed silicon-containing lithium-ion battery, wherein the pre-pressurization heating formation operation comprises the following steps:
performing a pre-swelling standing pre-treatment on the pre-formed silicon-containing lithium-ion battery under a pressure of F4;
performing a swelling-suppression charging pre-treatment on the pre-formed silicon-containing lithium-ion battery under a pressure F5 after the pre-swelling standing pre-treatment; and
performing a liquid absorption and slow-swelling standing pre-treatment on the pre-formed silicon-containing lithium-ion battery under a pressure of F6 after the swelling-suppression charging pre-treatment;
wherein
$$F 4 = F 5 , F 6 \leq F 4 , and F 4 < F 1 .$$

16. The formation method according to claim 15, wherein F4, F5 and F6 each are independently selected from 0.5 kgf/cm² to 5 kgf/cm².

17. The formation method according to claim 15, wherein performing a pre-swelling standing pre-treatment on the pre-formed silicon-containing lithium-ion battery under a pressure of F4 comprises standing for 5 min to 3 h under the pressure of F4; and/or
performing a liquid absorption and slow-swelling standing pre-treatment on the pre-formed silicon-containing lithium-ion battery under a pressure of F6 comprises standing for 5 min to 3 h under the pressure of F6.

18. The formation method according to claim 15, wherein the swelling-suppression charging pre-treatment on the pre-formed silicon-containing lithium-ion battery is performed at a current of 0.01 C to 0.5 C; and/or
the pre-formed silicon-containing lithium-ion battery is charged to 1% SOC to 5% SOC in the step of the swelling-suppression charging pre-treatment.

19. The formation method according to claim 15, wherein the pre-pressurization and heating formation operation is performed under a temperature of 35° C. to 80° C.

20. A computer-readable storage medium storing a computer program or instructions for being executed to perform the formation method of claim 10.
